(19) United States
(12) Patent Application Publication
(10) Pub. No.: US 2010/0161655 A1
(43) Pub. Date: Jun. 24, 2010

(54) SYSTEM FOR STRING MATCHING BASED ON SEGMENTATION METHOD AND METHOD THEREOF

(75) Inventors: Younhee GIL, Daejeon-City (KR); Dowon HONG, Daejeon-City (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-City (KR)

(21) Appl. No.: 12/643,555

(22) Filed: Dec. 21, 2009

(30) Foreign Application Priority Data
Dec. 22, 2008 (KR) 10-2008-0131571

(51) Int. Cl. G06F 17/30

(52) U.S. Cl. 707/769; 707/E17.014

(57) ABSTRACT

A device of searching a text string based on segmentation according to the present invention includes: a keyword input unit that receives a keyword; a segmentation unit that receives the keyword and constantly splits the received keyword into a search unit having one or more characters; and a search unit that extracts a generation position of each search unit in a search target file by searching each search unit of the keyword from the search target file and calculates similarity as the inputted keyword by using the extracted generation position. According to the present invention, a dictionary does not need to be previously organized at the time of creating an index database and a creation speed of the index database is increased and false extraction is minimized, thereby accurately searching a text string.

### RELATED APPLICATIONS

The present application claims priority to Korean Patent Application Serial Number 10-2008-0131571, filed on Dec. 22, 2008, the entirety of which is hereby incorporated by reference.

### BACKGROUND OF THE INVENTION

1. Field of the Invention

The present invention is related to the string matching system based on segmentation method and a method thereof. More particularly, the present invention is related to the string matching system which divides a keyword into some segments, character set of determined length, and searches the keyword by comparing the segments with elements of index database. The elements of index database are also the segments extracted from text file.

2. Description of the Related Art

There are many index word extraction methods for generating of an index database. Among them, dictionary based method, a morpheme analysis method, and a segmentation method are common. Brief explanation on how to extract index word in the dictionary based method, the morpheme analysis method, and the segmentation method will be described in the following, respectively.

In the dictionary based method, after a dictionary for a predetermined word is previously organized, an index database is created with respect to an index word for a phrase included in the dictionary. In addition, the morpheme analysis method is a method of extracting a word having a meaning by considering a context of a sentence or a grammatical aspect with respect to inputted text strings to create the elements of the index database. Further, the segmentation method is a method of splitting the text string into character sets of predetermined length and creating the index database for the divided character sets without considering a meaning of a word and a contextual relationship. In the segmentation method, an index database is created using the split character sets and it is determined whether or not a keyword is matched with the index word in the database by applying the same segmentation method to the keyword and comparing each split character sets.

The above-mentioned dictionary based method has one disadvantage in that an enormous amount of dictionary should be previously organized and another disadvantage in that words not included in the dictionary cannot be searched.

In the morpheme analysis method, since a morpheme analysis process is very complicated and various analysis possibilities are present with respect to the same phoneme, it takes a long time and the risk of false analysis is present.

Meanwhile, in order to solve the above-mentioned problems, a method of appropriately mixing the morpheme analysis method with the dictionary based method may be provided.

In addition, since the segmentation method is a method of creating the index database by splitting all words in the text string to be searched into character sets of predetermined length, the index database creating process is simple and rapid. However, the volume of the index database is large and the index word is excessively extracted at the time of creating the index database. In the case of creating the index database by using the segmentation method, the stopword may be first removed before text splitting.

### SUMMARY OF THE INVENTION

The present invention is contrived to solve the above-mentioned problems. An object of the present invention is to reduce the error caused by the excessive extraction of index words in the known segmentation method by considering the position information of each character set in the text. In particular, another object of the present invention is to index and search neologisms, cants, various foreign words (i.e., wine list, region name, etc.) written in foreign language that are not registered in the dictionary.

According to a first aspect of the present invention, the device for processing a search target text string includes: the input unit that receives the target text string to be searched; the segmentation unit that receives the text string and splits the received text string into some segments having one or more characters; and the index database generation unit that merges the duplicated segments and creates an index database using the segments as elements with their frequency and position information in the received text string.

In particular, the segmentation unit receives text string, removes stopwords, and splits each word into some segments.

Further, the segmentation unit extracts every word and splits each word into some segments, or extracts phrase by some specific characters, and then, splits them into some segments.

In addition, the segmentation unit splits the text string so that one or more characters are superimposed to each other.

Meanwhile, according to a second aspect of the present invention, the device for searching a text string includes: the input unit that receives a keyword; the segmentation unit that receives the keyword and splits the received keyword into some segments having one or more characters; and the search unit that searches the keyword through the index database by comparing the relative distance of position of each segments.

In particular, the segmentation unit receives text string, removes stopwords, and splits each word into some segments.

Further, the segmentation unit extracts every word and splits each word into some segments, or extracts phrase by some specific characters, and then, splits them into some segments.

In addition, the segmentation unit splits the text string so that one or more characters are superimposed to each other.

Further, the search unit calculates the similarity on the basis of the distance of segments between the keyword and target string stored in the database.

Meanwhile, according to the third aspect of the present invention, the method of processing a search target text string includes: receiving the target text string to be searched; splitting the received target text string into some segments having one or more characters; merging the duplicated segments; and creating the index database using the segments as elements with their frequency and position information in the received text string.

In particular, the step of splitting the received text string into some segments having one or more characters includes removing a stopword from the received target text string.

Further, the step of splitting the received text string into some segments extracts every word and splits each word into some segments, or extracts phrase by some specific characters, and then, splits them into some segments.

Further, the step of splitting the received target text string into some segments splits the text string so that one or more characters are superimposed to each other.

Meanwhile, according to a fourth aspect of the present invention, a method of searching a text string includes: receiving a keyword; splitting the received keyword into some segments having one or more characters; and searching the keyword through the index database by comparing the relative distance of position of each segment.

In particular, the step of splitting the received keyword, removes stop words, and splits each word into some segments.

Further, the step of splitting the received keyword extracts every word and splits each word into some segments, or extracts phrase by some specific characters, and then, splits them into some segments.

Further, the step of splitting the received keyword splits the text string so that one or more characters are superimposed to each other.

In addition, the step of searching calculates the similarity on the basis of the relative distance of segments between the keyword and target string stored in the database.

The following effects can be obtained by the present invention.

According to an embodiment of the present invention, while searching a predetermined text string after creating an index database by extracting the index word for a text string to be searched, a dictionary does not need to be previously organized at the time of creating the index database, thus, an index database creation speed is increased and false extraction is minimized, thereby accurately searching the text string.

Further, it is possible to index and search neologisms, cants, various foreign words (i.e., wine list, region name, etc.) written in English language that are not registered in a dictionary. In addition, it is possible to determine whether or not a corresponding keyword is included in a file searched by setting a threshold value for a distance between search units and setting a threshold value of an entire similarity value. That is, by flexibly setting a threshold value with respect to a logical separation distance between the search units, even when a blank or a special character is provided between two search units, the file can be searched and only a file including an accurately matched word can be searched by adjusting the threshold value.

### BRIEF DESCRIPTION OF THE DRAWINGS

FIG. 1 is a block diagram for specifically describing a configuration of a device of processing a text string to be searched according to an embodiment of the present invention;

FIG. 2 is an exemplary diagram for describing a process of splitting an input text string (search target text string) by the phrase unit;

FIG. 3 is an exemplary diagram for describing a process of splitting an input text string split by the phrase unit by the N-character segment in FIG. 2;

FIG. 4 is a diagram illustrating an example of a data structure for creating an index database of each text segment;

FIG. 5 is a block diagram for specifically describing a configuration of a device of searching a text string based on segmentation method according to an embodiment of the present invention;

FIG. 6 is an exemplary diagram for illustrating a position generation of a corresponding segment of a keyword in the target file to be searched when the keyword exists in the target file;

FIG. 7 is an exemplary diagram for describing a position generation of a corresponding segment of a keyword in the target file to be searched when the keyword does not exist in the target file;

FIGS. 8A and 8B are exemplary diagrams for describing a method of calculating similarity between the keyword and text in the target file using the location information of segments extracted from the keyword;

FIG. 9 is a flowchart for specifically describing a method of processing a text string to be searched according to an embodiment of the present invention; and

FIG. 10 is a flowchart for specifically describing a method of searching a target string based on segmentation method according to an embodiment of the present invention.

### DETAILED DESCRIPTION OF THE PREFERRED EMBODIMENTS

The present invention will be described below with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the figures may be exaggerated for explicit comprehension.

Hereinafter, preferred embodiments of the present invention will be described in detail with reference to the accompanying drawings.

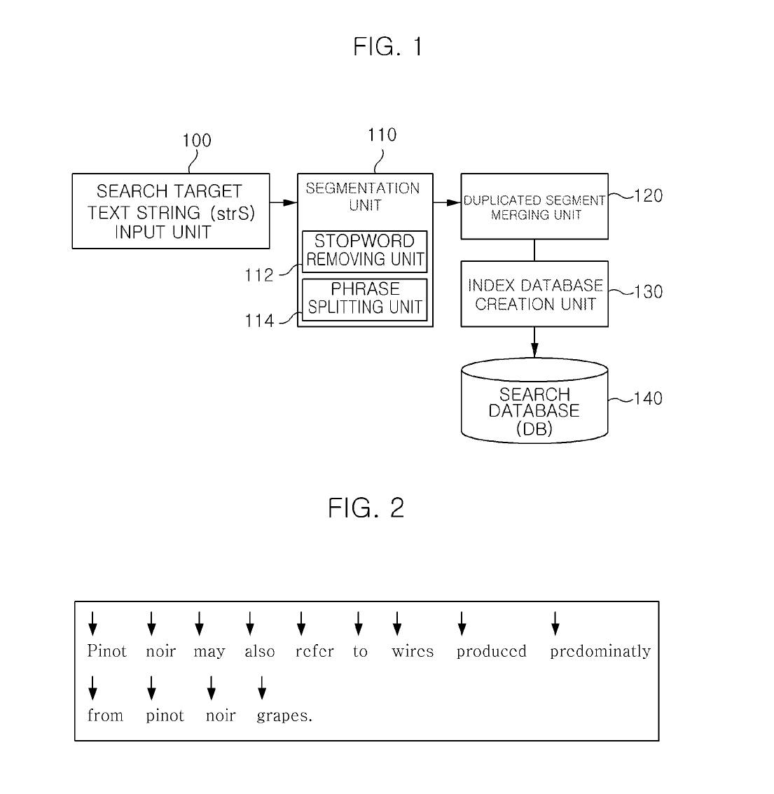

FIG. 1 is a block diagram for specifically describing a configuration of a device of processing a search target text string according to an embodiment of the present invention.

The device of processing a search target text string includes a search target text string (strS) input unit 100, a segmentation unit 110, a duplicated segment merging unit 120, an index database creation unit 130, and a search database 140 (search DB).

The search target text string input unit 100 receives a search target text string (strS) and transmits the received search target text string (strS) to the segmentation unit 110.

The segmentation unit 110 receives the search target text string from the search target text string input unit 100 to control a stopword and splits the search target text string without the stopword by the phrase unit. In addition, the segmentation unit 110 splits the search target text string split by the phrase unit into one or more search target units for each phrase. At this time, the unit is split into regular array such as N-character in the case of English language (‘N’ is a natural number).

In addition, it will be easily appreciated by those skilled in the art that the present invention can be applied to languages (e.g., German, French, Spanish, Italian, Portuguese, etc.) having a meaning by arraying alphabets including Latin alphabets and all characters (e.g., Cyrillic characters, etc.) having the same root as the Latin alphabets in addition to English.

More specifically, in order to achieve the above description, the segmentation unit 110 includes a stopword removing unit 112 and a phrase splitting unit 114.

The stopword removing unit 112 removes the stopword included in the search target text string (strS). The stopword removing unit 112 removes the stopword included in the search target text string (strS) by referring to a stopword dictionary. Herein, the stopword represents a word from which meaningful information is difficult to be acquired when the stopword is included in a search target. That is, the stopword includes words which are worthless of creating an index database, such as articles, prepositions, auxiliary words, conjunctions, etc. they are not used as search terms. Removal of the stopword may depend on a referenced stopword dictionary. Further, the stopword removing unit 112 may use various known stopword removal algorithms in order to remove the stopword.

The phrase splitting unit 114 splits the search target text string without the stopword by the phrase unit through the stopword removing unit 112. Herein, the phrase splitting unit 114 may split the phrase on the basis of a blank, a special character, etc. or split the phrase on the basis of the foreign language and the English language. In addition, the phrase splitting unit 114 may split a phrase on different bases depending on the applications. For example, splitting bases can be designated by symbols or characters designated by a user.

FIG. 2 is an exemplary diagram for describing a process of splitting an inputted text string (search target text string) by the phrase unit in the phrase splitting unit 114. In FIG. 2, a text string including a name of wine is exemplified and a first character of the split phrase is indicated by an arrow.

An example sentence in FIG. 2 is split by the phrase unit on the basis of the symbol and blank.

Meanwhile, the name of wine may be variously written in English language and since names of new types of wines are continuously generated, the names are words that will not be included in the dictionary as the case may be. That is, the text string including the name of wine, which is shown in FIG. 2 has a limit in extracting an index word in order to create the index database by using a dictionary based method. This is because in the dictionary based method, after a dictionary for a predetermined word is previously organized, an index database is created with respect to an index word for a phrase included in the dictionary.

However, according to the present invention, it is possible to create index database with respect to neologisms, cants, various foreign words (i.e., wine name, region name, etc.), which are not registered in the dictionary and in addition, to search them. This will be described in detail through a construction process and a search process of a search database in the present invention to be described below.

As shown in FIG. 2, the segmentation unit 110 constantly splits the search target text string split by the phrase unit into the search target unit of N-character. The number of characters into which the search target unit will be split may depend on the applications.

In the embodiment of the present invention, when the search target text string is the foreign languages including the English language, the search target text string is split by using the N-character as one search target unit.

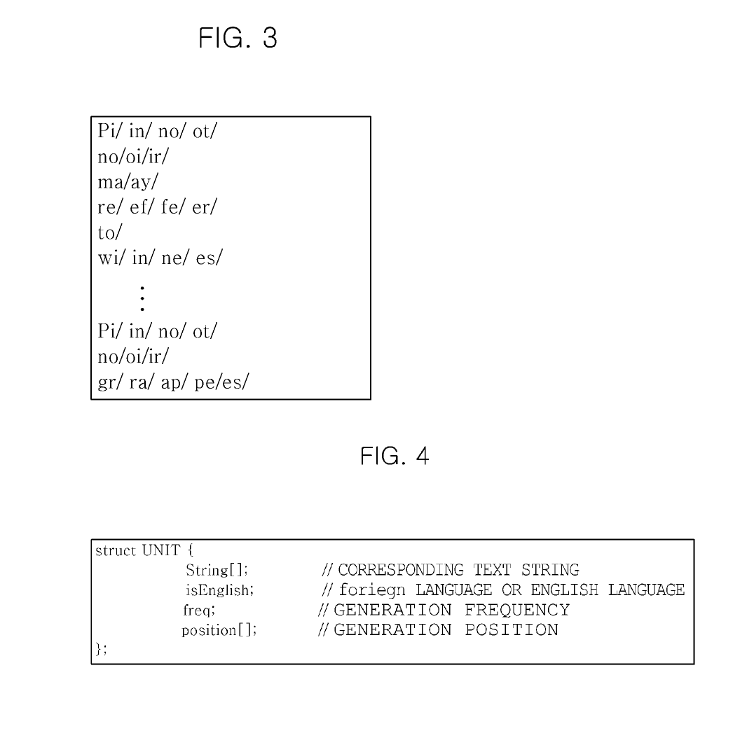

FIG. 3 illustrates an example in which the search target text string that is split by the phrase unit and includes the wine name, and foreign words is split into a search target unit of two characters.

When “Pinot noir may also refer to wines produced predominantly from Pinot noir grapes.” which is the example sentence of FIG. 2 is split by the search target unit of 2-characters, the split sentence is expressed as shown in FIG. 3. At this time, as described above, when the search target text string is split by the search target unit of N-character, the splitting method may depend on the applications.

As shown in FIG. 3, when the search target text string is split by the unit having plural characters at the time of splitting the search target text string by the search target unit, it is preferable to split the search target text string so that one or more characters are superimposed to each other. In this case, it is possible to split the search target text string so that the search target unit has the same number of characters regardless of the number of characters constituting the phrase.

For example, in the example sentence of FIG. 2, when ‘Pinot’ which is one phrase is split by the search target unit of 2-characters, the phrase can be split into ‘Pi/in/no/ot’ and when ‘Pinot’ is split by the search target unit of 3-characters, the phrase can be split by ‘Pin/ino/not’.

For example, in the example sentence of FIG. 2, when ‘wine’ which is another phrase is split by the search target unit of 2-characters, the phrase can be split into ‘wi/in/ne’ and when ‘wine’ is split by the search target unit of 3-characters, the phrase can be split by ‘win/ine’.

Meanwhile, as the number (N) of characters constituting one search target unit decreases, the volume of index database to be created increases, but it is possible to achieve more accurate search result.

When the search target text string is split by the phrase unit and thereafter, the phrase is split by the search target unit of N-character, it is preferable that the phrase is split by setting 2 characters or 3 characters as one unit. When the number of characters constituting one unit is too small, the number of index word to be stored increases, the volume of the index database becomes large, and excessive extraction may occur. In addition, when the number of characters constituting one unit increases, the number of index word to be stored decreases. But the accuracy of the search result may deteriorate.

However, as described above, the number of characters into which the search target unit will be split may depend on the applications.

Meanwhile, in the embodiment of the present invention, the stopword is removed in the segmentation unit 110, the search target text string without the stopword is split by the phrase unit, and the search target text string is split by the search target unit of N-character.

However, the search target text string can be directly split by the search target unit of N-character without removing the stopword and splitting the search target text string by the phrase unit in the segmentation unit 110 as necessary. This can be selectively set at the time of constructing a search system.

For example, a case in which the example sentence of FIG. 2 is split by the search target unit of 2-characters without splitting the search target text string by the phrase unit in the segmentation unit 110 can be expressed as follows.

The example sentence can be split into “Pi/in/ot/tN/No/oi/ir/rm/ma/ay/ya/al/ls/so/or . . . Pi/in/no/ot/tN/No/oi/ir/rg/gr/ra/ap/pe/es/”.

The duplicated segment merging unit 120 removes search target units duplicated in the search target text string that is split by the search target unit of N-character through the segmentation unit 110. In other words, when the same search target unit is present, the duplicated segment merging unit 120 can create one index database corresponding to all of a plurality of same units. At this time, the generation frequency and information of generation positions of the duplicated units are recorded in the created index database. That is, the generation frequency is increased by 1 whenever removing the duplicated search target unit and the generation position is added in the search target text string.

For example, when “Pinot noir may also refer to wines produced predominantly from Pinot noir grapes.” which is the search target text string is split by the unit of 2-characters, the search target unit, ‘oi’ is included in the search target text string two times and the search target unit, ‘in’ is included in the search target text string four times.

The duplicated segment merging unit 120 removes the duplicated units such as ‘oi’ and ‘in’ in the example sentence of FIG. 2 and determines the generation frequency and generation positions of the duplicated units so as to create an index database having a data structure shown in FIG. 4 and transfers them to the index database creation unit 130 at the time of removing the duplicated units.

The index database creation unit 130 sorts the search target text string without the duplicated searched target units, and creates the index database in which information relating to each search target unit is recorded in the data structure shown in FIG. 4 and finally constructs an index database table. At this time, when the index database is created in the index database creation unit 130, the index database for each unit is created by referring to the result value (that is, the frequency and information on the generation positions for the duplicated units) transferred from the duplicated unit removing unit 120. For example, when the index database creation unit 130 creates the index database for ‘in’ in the example sentence of FIG. 2, ‘4’ is recorded in the index database of the searched target unit, ‘in’ as the generation frequency and positional information of four different locations is recorded the index database as the generation position. For example, the positional information may be recorded as a numeral. The index database information may be recorded in a predetermined data structure such as a Trie structure or a B-tree. Herein, the B-tree is a tree-type data structure configured to efficiently update a large-capacity file. This structure is a generalized data structure of a binary tree which can have two edges or less.

By creating only one index database with respect to the duplicated search target units at the time of creating the index database in the index database creation unit 130 and recording the generation frequency and generation position of the corresponding unit for the index database, the index database does not need to be created with respect to each of the duplicated search target units and it is possible to prevent the volume of the index database from being increased.

Meanwhile, for convenience of description, in FIG. 1, although the duplicated segment merging unit 120 and the index database creation unit 130 are separately configured, they can be integrated and implemented by one configuration.

The search target text string (strS) and the index database information created by the index database creation unit 130 are stored in the search database 140 (search DB). The search database 140 includes index database.

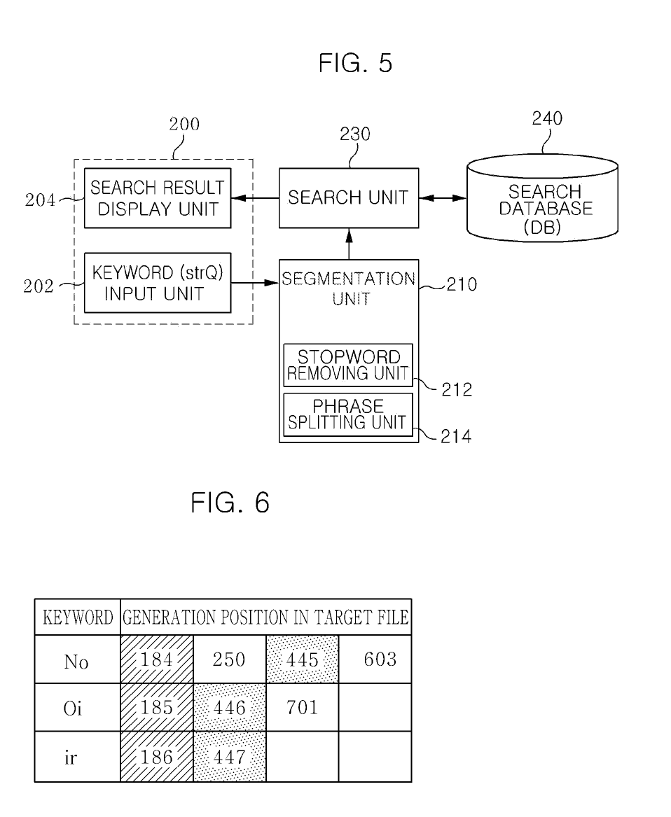

FIG. 5 is a block diagram for specifically describing a configuration of a device of searching a text string based on segmentation according to an embodiment of the present invention.

The device of searching a text string based on segmentation according to the embodiment of the present invention includes an interaction unit 200, a segmentation unit 210, a search unit 230, and a search database 240 (hereinafter, referred to as ‘search DB’).

The interaction unit 200 receives a keyword (strQ) for an inquiry from the user and transfers the received keyword (strQ) to the segmentation unit 210 and receives a search result from the search unit 230 and allows the search result to be displayed to the user as screen information.

For this, the interaction unit 200 includes a keyword (strQ) input unit 202 and the search result display unit 204. The keyword input unit 202 receives the keyword from the user and transfers the received keyword to the segmentation unit 210. In addition, the search result display unit 204 receives the search result from the search unit 230 and displays the received search result to the user as the screen information.

The segmentation unit 210 receives the keyword for the inquiry from the keyword input unit 202 and removes the stopword, and splits the keyword without the stopword by the phrase unit. In addition, the segmentation unit 210 constantly splits the keyword split by the phrase unit into the search unit of N-character for each phrase.

More specifically, in order to achieve the above description, the segmentation unit 210 includes a stopword removing unit 212 and a phrase splitting unit 214.

The stopword removing unit 212 removes the stopword included in the keyword. That is, the stopword removing unit 212 removes the stopword from the keyword by referring to the stopword dictionary. The stopword removing unit 212 may use various known stopword removal algorithms in order to remove the stopword.

The phrase splitting unit 214 splits the keyword without the stopword by the phrase unit through the stopword removing unit 212. Herein, the phrase splitting unit 214 may split the phrase on the basis of a blank, a special character, etc. or split the phrase on the basis of the foreign language and the English language. In addition, the phrase splitting unit 214 may split the phrase on different bases depending on the applications. For example, splitting bases can be designated by symbols or characters designated by the user.

When the keywords inputted into the segmentation unit 210 through the keyword input unit 202 are “chardonnay” and “red”, the segmentation unit 210 can split “chardonnay” into the search unit of 2-characters such as ‘ch/ha/ar/rd/do/on/nn/na/ay’ and split “red” into the search unit of 2-characters such as ‘re/ed’, respectively.

Meanwhile, in the embodiment of the present invention, the stopword is removed in the segmentation unit 210, the keyword without the stopword is split by the phrase unit, and the keyword is split by the unit of N-character. However, as described above through the process of processing the search target text string, the keyword can be directly split into the search unit of N-character without removing the stopword for the keyword and splitting the keyword by the phrase unit in the segmentation unit 210. This can be selectively set at the time of constructing a search system. Further, when the keyword is split into a search unit having a plurality of characters at the time of constantly splitting the keyword into the search unit, it is preferable to split the keyword so that one or more characters are superimposed to each other. In this case, it is possible to split the keyword so that the search unit has the same number of characters regardless of the number of characters constituting the phrase.

The search unit 230 receives the keyword split into the search unit of N-character through the segmentation unit 210, searching is performed by using an index database table of a search target file stored in the search database 240, and information on a generation position of each search unit in the search target file is extracted. In addition, the search unit 230 calculates similarity as the received keyword by using the extracted generation position information. Herein, it is assumed that the index database table of the search target file that has passed the process of processing the search target text string described in FIGS. 1 to 4 is stored.

Hereinafter, the method of extracting the generation position information of each search unit in the search target file in the search unit 230 and calculating the similarity as the inputted keyword by using the extracted generation position information will be described in detail.

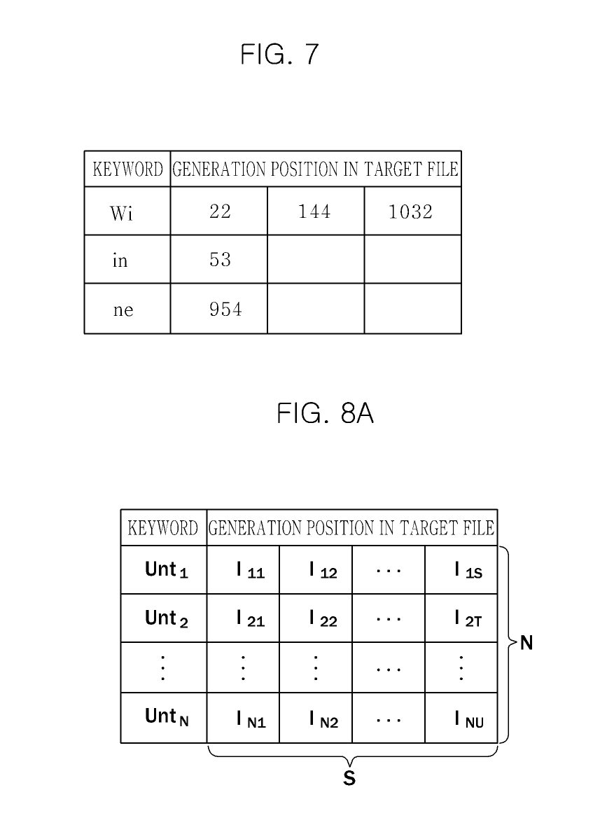

First, FIG. 6 is an exemplary diagram for illustrating a generation position of a corresponding search unit in a search target file when a keyword inputted by the search target file is provided. In addition, FIG. 7 is an exemplary diagram for describing a generation position of a corresponding search unit in a search target file when a keyword inputted by a search target file is not provided.

FIGS. 6 and 7 illustrate generation position values of the corresponding search unit when the search unit of each keyword is provided in a predetermined file (search target file) with respect to a keyword, ‘Noir’ and a keyword ‘wine’.

When each keyword is split into the search unit of 2-characters by the above-mentioned keyword processing process, “Noir” is split into ‘No/oi/ir’ and “wine” is split into ‘wi/in/ne’.

First, in the search method based on the search unit of N-character, it is determined that the search target file including all the search units constituting the keyword is a file including the corresponding keyword. However, it may be mis-determined by disregarding the sequence and considering only whether or not the search unit is included. For example, although the keyword “wine” needs to be searched, files in which ‘wi’, ‘in’, and ‘ne’ are provided at different positions will also be searched. That is, files including text strings such as ‘wide’, ‘inside’, and ‘negotiation’ can be searched. However, since files that do not include the word “wine” are actually searched, this can be regarded as false extraction or excessive extraction.

In order to prevent such a case from being generated, in the present invention, similarity of each search unit as the inputted keyword is calculated by considering the generation position of the search unit constituting the keyword in the search target file.

As the search result after the keyword “Noir” is split into the search unit of 2-character, when generation position values of the search units such as ‘No’, ‘oi’, and ‘ir’ constituting the keyword “Noir” are adjacent to each other such as ‘184, 185, 186 ’ and 445, 446, 447′ as shown in FIG. 6, it is determined that the keyword “Noir” is found in the search target file twice.

On the contrary, as the search result after the keyword “wine” is split into the search unit of 2-character, when generation position values of the search units ‘wi’, ‘in’, and ‘ne’ constituting the keyword “wine” are shown in FIG. 7, it is determined that the keyword “wine” is not found in the search target file.

As described above, in the present invention, it is determined whether or not the keyword is found in the search target file by calculating the similarity of each search unit as the inputted keyword on the basis of a logical separation distance between the search units. That is, when the search unit 230 of the present invention searches each search unit of the keyword in the search target file and extracts the generation position of each search unit from the search target file, calculates the logical separation distance between the search units by using the extracted generation position of each search unit, and the similarity of each search unit as the keyword is calculated on the basis of calculated distance, it is determined whether or not the keyword is found in the search target file.

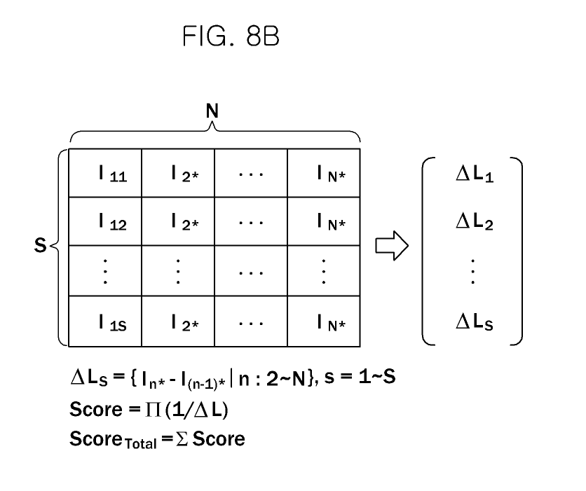

FIGS. 8A and 8B are exemplary diagrams for describing a method of calculating similarity as a keyword inputted by the search unit 230 by using a generation position of a keyword in a search target file.

First, when the search unit of the inputted keyword is constituted by Untₙ(n:1˜N) and generation positions of the search units in the search target file are {Iₙ₁, Iₙ₂, Iₙ₃|n:1˜N, s:variable}, it is determined that a generation position of a first search unit is a position where the keyword can be found. Accordingly, a generation position most adjacent to {I₁ₛ|s:1˜S} among generation positions of the follow-up search units is extracted. Equation 1 is used to calculate the logical separation distance between the search units.

ΔLₛ={Iₙ*I₍ₙ₋₁₎*|n:2˜N},s−1˜S [Equation 1]

In addition, Equation 2 is used to calculate the similarity as the keyword.

Score=π(1/Δ) [Equation 2]

In addition, overall similarity of the search target file is calculated by using a sum of similarity values.

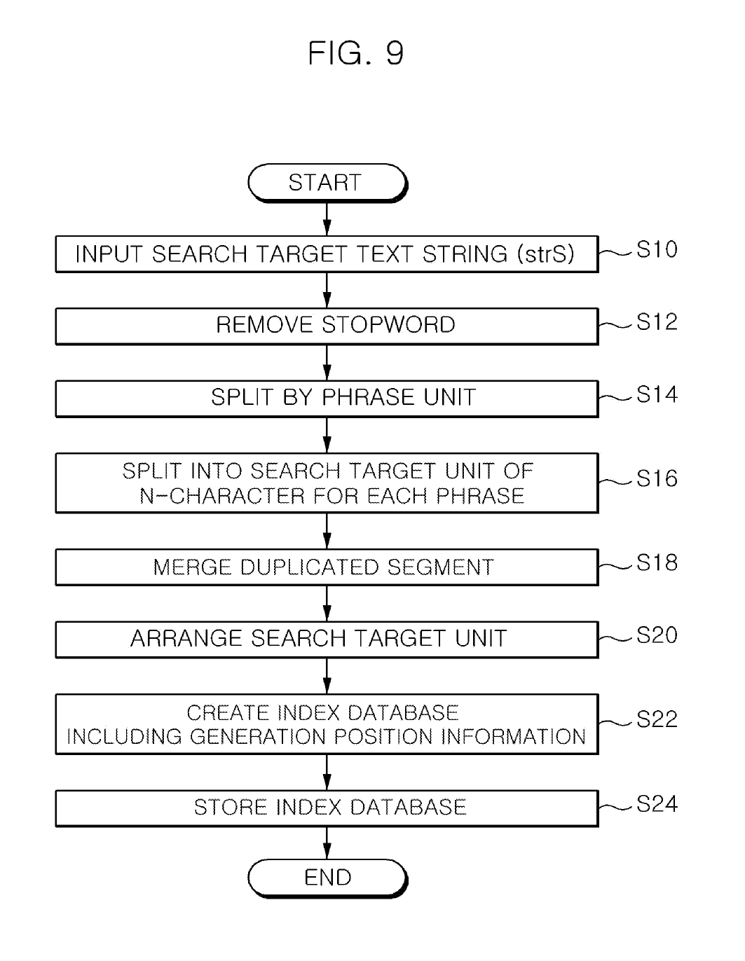

FIG. 9 is a flowchart for specifically describing a method of processing a search target text string according to an embodiment of the present invention.

First, a search target text string is inputted (S10). In addition, a stopword is removed from the inputted search target text string by referring to a stopword dictionary (S12). At step S12, various known stopword removal algorithms may be used in order to remove the stopword.

Next, at step S12, the search target text string without the stopword is split by the phrase unit (S14). Herein, the phrase may be split on the basis of a blank, a special character, etc. or the phrase may be split on the basis of a foreign language and an English language. The phrase may be split on different bases depending on the applications. For example, of course, splitting bases can be designated by symbols or characters designated by a user.

Through step S14, when the search target text string is split by the phrase unit, the search target text string split by the phrase unit is split into a search target unit of N-character for each phrase (S16). When the search target text string is split by the unit having plural characters at the time of constantly splitting the search target text string by the search target unit, it is preferable to split the search target text string so that one or more characters are superimposed to each other. In this case, it is possible to split the phrase so that the search target unit has the same number of characters regardless of the number of characters constituting the phrase. For example, in the case when one phrase of the search target text string is ‘number’, the phrase can be split into ‘nu/um/mb/be/er’ by splitting the phrase into the search target unit of 2-characters.

Meanwhile, in the above description, the stopword is removed from the search target text string, the search target text string is split by the phrase unit for the search target text string without the stopword, and the search target text string is split into the search target unit of N-character for each phrase.

However, the stopword removing step (S12) and the phrase unit splitting step (S14) may be omitted as necessary. That is, the search target text string can be directly split into the search target unit of N-character. This can be selectively set at the time of constructing a search system.

Through step S16, when the search target text string is split into the search target unit of N-character for each phrase, duplicated search target units are removed (S18). That is, when the same search target unit is present, one index database corresponding to all of a plurality of same units can be created. At this time, the generation frequency and information of generation positions of the duplicated units are recorded in the created index database. At step S18, the generation frequency is increased by 1 whenever removing the duplicated search target unit and the generation position of the corresponding search target unit is added in the search target text string.

Next, the search target units are sorted and the index database in which relevant information on each search target unit is recorded in a data structure shown in FIG. 4 are created (S22). At this time, the generation frequency and generation position information of the search target unit in the search target text string (search target file) are recorded in the created index database.

As described above, by creating only one index database with respect to the duplicated search target units at the time of creating the index database and recording the generation frequency and generation position of the corresponding unit for the index database, the index database does not need to be created with respect to each of the duplicated search target units and it is possible to prevent the volume of the index database from being increased.

In addition, the index database created at step S22 is cleaned up and stored in a table format (S24).

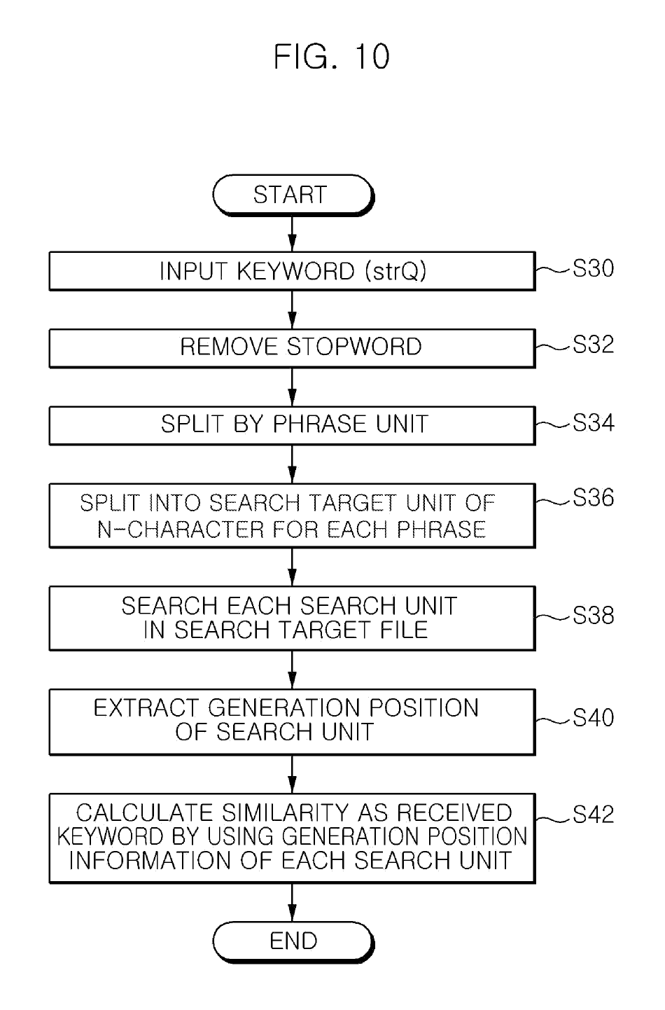

FIG. 10 is a flowchart for specifically describing a method of searching a text string based on segmentation according to an embodiment of the present invention.

First, a keyword for an inquiry is inputted (S30). In addition, the stopword is removed from the inputted keyword by referring to the stopword dictionary (S32). At step S32, various known stopword removal algorithms may be used in order to the stopword.

Next, at step S32, the keyword without the stopword is split by the phrase unit (S34). Herein, the phrase may be split on the basis of the blank, the special character, etc. or the phrase may be split on the basis of the foreign language and the English language. Besides, the phrase may be split on different bases depending on applications. For example, of course, splitting bases can be designated by the symbols or characters designated by the user.

Through step S34, when the keyword is split, the keyword split by the phrase unit is split into the search unit of N-character for each phrase (S36). When the keyword is split by the unit having plural characters at the time of constantly splitting the keyword by the search unit, it is preferable to split the keyword so that one or more characters are superimposed to each other. In this case, it is possible to split the keyword so that the search unit has the same number of characters regardless of the number of characters constituting the phrase.

Meanwhile, in the above description, the stopword is removed from the keyword, the keyword is split by the phrase unit for the keyword without the stopword, and the keyword is split into the search unit of N-character for each phrase. However, the stopword removing step (S32) and the phrase unit splitting step (S34) may be omitted as necessary. That is, the keyword can be directly split into the search unit of N-character. This can be selectively set at the time of constructing a search system.

Next, through step S36, the search is performed by using the index database table of the search target file stored in a search database by receiving the keyword split into the unit of the N-character and the generation position information for each search unit is extracted in the search target file (S40). Herein, it is assumed that the index database table of the search target file that has passed the process of processing the search target text string described in FIG. 9 is stored in the search database.

In addition, similarity as the inputted keyword is calculated by using the generation position information extracted at step S40 (S42). More specifically, a logical separation distance between the search units is calculated by using the extracted generation position of each search unit and the similarity of each search unit as the keyword is calculated on the basis of the calculated distance, such that it is determined whether or not the keyword is found in the search target file.

Meanwhile, finally, it is possible to determine whether or not a corresponding keyword is included in a file searched by setting a threshold value for a distance between search units and setting a threshold value of an entire similarity value. That is, by flexibly setting a threshold value with respect to a logical separation distance between the search units, even when a blank or a special character is provided between two search units, the file can be searched and only a file including an accurately matched word can be searched by adjusting the threshold value. For example, when the search is performed by using “worldseries” as the keyword, “worldseries” or “world series” may be included in the search result and only one accurately matched with “worldseries” can be searched.

Some steps of the present invention can be implemented as a computer-readable code in a computer-readable recording medium. The computer-readable recording media includes all types of recording apparatuses in which data that can be read by a computer system is stored. Examples of the computer-readable recording media include a ROM, a RAM, a CD-ROM, a CD-RW, a magnetic tape, a floppy disk, an HDD, an optical disk, a magneto-optical storage device, etc. and in addition, include a recording medium implemented in the form of a carrier wave (for example, transmission through the Internet). Further, the computer-readable recording media are distributed on computer systems connected through the network, and thus the computer-readable recording media may be stored and executed as the computer-readable code by a distribution scheme.

As described above, the preferred embodiments have been described and illustrated in the drawings and the description. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A device of processing a search target text string for creating an index database, comprising:
a search target text string input unit that receives the search target text string;
a segmentation unit that receives the search target text string and constantly splits the received search target text string into a search target unit having one or more characters; and
an index database creation unit that removes duplicated search target units from the split search target text string and creates an index database including a generation frequency and information on a generation position of each search target unit in the search target text string.

2. The device of processing a search target text string according to claim 1, wherein the segmentation unit removes a stopword by receiving the search target text string, splits the search target text string without the stopword by the phrase unit, and constantly splits the search target text string into a unit having one or more characters for each phrase.

3. The device of processing a search target text string according to claim 2, wherein the segmentation unit splits the search target text string without the stopword by the phrase unit by using at least one of a blank, a special character, a symbol designated by a user, and a character designated by the user as a splitting basis.

4. The device of processing a search target text string according to claim 1, wherein the segmentation unit splits the search target text string so that one or more characters are superimposed to each other when the search target text string is constantly split into the search target unit having the plurality of characters.

5. A device of searching a text string based on segmentation, comprising:
a keyword input unit that receives a keyword;
a segmentation unit that receives the keyword and constantly splits the received keyword into a search unit having one or more characters; and
a search unit that extracts a generation position of each search unit in a search target file by searching each search unit of the keyword from the search target file and calculates similarity as the inputted keyword by using the extracted generation position.

6. The device of searching a text string according to claim 5, wherein the segmentation unit removes the stopword by receiving the keyword, splits the keyword without the stopword by the phrase unit, and constantly splits the keyword into a search unit having one or more characters for each phrase.

7. The device of searching a text string according to claim 6, wherein the segmentation unit splits the keyword without the stopword by the phrase unit by using at least one of a blank, a special character, a symbol designated by a user, and a character designated by the user as a splitting basis.

8. The device of searching a text string according to claim 5, wherein the search unit calculates the similarity on the basis of a logical separation distance between the search units.

9. The device of searching a text string according to claim 6, wherein the segmentation unit splits the keyword so that one or more characters are superimposed to each other when the keyword is constantly split into the search unit having the plurality of characters.

10. A method of processing a search target text string for creating an index database, comprising:
receiving the search target text string;
constantly splitting the received search target text string into a search target unit having one or more characters;
removing duplicated search target units from the search target text string split into the search target unit; and
creating the index database including information of a generation position on each search target unit.

11. The method of processing a search target text string according to claim 10, wherein constantly splitting the received search target text string into the search target unit having one or more characters includes removing a stopword from the inputted search target text string.

12. The method of processing a search target text string according to claim 10, wherein in constantly splitting the received search target text string into the search target unit having one or more characters, the received search target text string is split by the phrase unit and the phrase is constantly split into a unit having one or more characters for each phrase.

13. The method of processing a search target text string according to claim 10, wherein in constantly splitting the received search target text string into the search target unit having one or more characters, when the search target text string is constantly split into a search target unit having a plurality of characters, the search target text string is split so that one or more characters are superimposed to each other.

14. A method of searching a text string based on segmentation, comprising:
receiving a keyword;
constantly splitting the received keyword into a search unit having one or more characters;
searching search units constituting the keyword in a search target file and extracting generation positions of the search units in the search target file; and
calculating similarity as the received keyword by using the extracted generation positions of the search units.

15. The method of searching a text string according to claim 14, wherein constantly splitting the received keyword into the search unit having one or more characters includes removing a stopword from the received keyword.

16. The method of searching a text string according to claim 14, wherein in constantly splitting the received keyword into the search unit having one or more characters, the received keyword is split by the phrase unit and the phrase is constantly split into a unit having one or more characters for each phrase.

17. The method of searching a text string according to claim 16, wherein in splitting the received keyword by the phrase unit, the received keyword is split by using at least one of a blank, a special character, a symbol designated by a user, and a character designated by the user as a splitting basis.

18. The method of searching a text string according to claim 14, wherein in calculating similarity as the received keyword by using the extracted generation positions of the search units, a logical separation distance between the search units is calculated by using the extracted generation positions of the search units and the similarity is calculated on the basis of the calculated logical separation distance.

19. The method of searching a text string according to claim 14, wherein in constantly splitting the received keyword into the search unit having one or more characters, when the keyword is constantly split into a unit having a plurality of characters, the keyword is split so that one or more characters are superimposed to each other.
